(19) United States
(12) Patent Application Publication
(10) Pub. No.: US 2012/0318560 A1
(43) Pub. Date: Dec. 20, 2012

(54) Conductive Bus Bars and Assembly

(76) Inventors: David Roger Sommer, Bloomington, IL (US); Ralph James Dinges, Bloomington, IL (US); Hoyma Joel Mazara, Santo Domingo (DO)

(21) Appl. No.: 13/162,887

(22) Filed: Jun. 17, 2011

(51) Int. Cl. H01B 5/02; H01B 5/00

(52) U.S. Cl. 174/129 B; 174/133 B

(57) ABSTRACT

A plurality of improved conductive bus bars together form an improved set of bus bars. Each bus bar has a first connection element, a second connection element, and an intermediate connection element electrically extending between the first and second connection elements. The intermediate connection element includes a pair of bend elements that cause the bus bar to be of a complex bent shape.

### BACKGROUND

1. Field The disclosed and claimed concept relates generally to electrical apparatuses and, more particularly, to bus bars that can be used to connect an electrical device with a line conductor and/or a load conductor.

2. Related Art

Numerous types of electrical apparatuses are known, including switching apparatuses, metering apparatuses, and devices which perform functions by consuming electrical power. Numerous types of conductors are known for use in making electrical connections among electrical apparatuses, such as flexible stranded wire, flexible solid wire, bus bars, and the like.

As a general matter, bus bars that possess a given current carrying capability typically are less expensive to manufacture than flexible stranded wire or flexible solid wire conductors having the same current carrying capability. Bus bars typically are formed of a solid piece of conductive material such as copper, aluminum, silver, and the like and thus are relatively rigid. Such bus bars are mechanically and electrically connected to other conductive structures through the use of fasteners, by way of example. While such bus bars have been generally effective for their intended purposes, such bus bars have not been without limitation.

In certain applications, a certain degree of difficulty has been encountered using bus bars for electrical connections. By way of example, a typical electrical meter is connected with both the line and the load and measures the electrical power that is used by a consumer. The meters themselves typically are made to be removable and replaceable, and such meters therefore typically are made to interact with a meter mount which is an electrical apparatus having a number of conductive elements to which the line and load conductive bus bars are attached. The meter mount further includes a number of electrical contacts for detachably electrically connecting a meter with the meter mount. The meter mount and the bus bars connected thereto typically are situated in a first electrical enclosure which is mounted to another electrical enclosure that may include a switching system on the line side. In order to enable such bus bars to provide electrical connections among the various components and the various enclosures, multiple bus bars extending in various directions have been fastened together. In the electrical metering example such interconnections between bus bars have been difficult to access from outside the first enclosure, making installation and adjustment difficult. Moreover, and depending upon the current carrying requirements of the application, insulative braces have been employed to avoid adjacent bus bars from shorting against one another during testing and usage. Also, the complicated interconnections between bus bar elements to enable the bus bars to extend in the various directions required has necessitated the use of relatively large amounts of conductive materials such as copper, and the like. It thus would be desirable to provide an improved system for providing electrical interconnections using bus bars.

### SUMMARY

In accordance with the disclosed and claimed concept, a plurality of improved conductive bus bars together form an improved set of bus bars. Each bus bar has a first connection element, a second connection element, and an intermediate connection element electrically extending between the first and second connection elements. The intermediate connection element includes a pair of bend elements that cause the bus bar to be of a complex bent shape.

In the exemplary embodiment depicted herein, the set of bus bars includes six bus bars that are each of different configurations. On some of the bus bars, the second connection element is straight, while in other bus bars the second connection element is curved. Moreover, while on some of the bus bars the first connection element and the second connection element extend in a common direction from the intermediate connection element and thus at least partially overlie one another, on other bus bars the first and second connection elements extend in opposite directions from the intermediate connection element. Moreover, the second connection element of some of the bus bars is configured to include a plurality of protrusions to enable the non-rotatable mounting of a wire connector, while on other bus bars the second connection element has a hole formed therein that is configured to non-rotatably receive a fastener therein.

Accordingly, an aspect of the disclosed and claimed concept is to provide an improved bus bar having a plurality of bends formed therein.

Another aspect of the disclosed and claimed concept is to provide an improved set of bus bars each having a plurality of bends formed therein.

Another aspect of the disclosed and claimed concept is to provide an improved assembly that includes an improved set of conductive bus bars and an apparatus, wherein the bus bars are electrically connected with the apparatus.

As such, an aspect of the disclosed and claimed concept is to provide an improved conductive bus bar. The general nature of the bus bar can be stated as including a first connection element structured to be electrically connected with a conductive element of an apparatus, a second connection element structured to be electrically connected with a conductor, and an intermediate connection element electrically extending between the first and second connection elements. The intermediate connection element includes a first bend element, a middle element, and a second bend element. The first bend element electrically extends between the first connection element and the middle element. The second bend element electrically extends between the second connection element and the middle element.

Another aspect of the disclosed and claimed concept is to provide an improved set of conductive bus bars that comprises a plurality of bus bars as set forth in the preceding paragraph.

Another aspect of the disclosed and claimed concept is to provide an improved assembly comprising the set of conductive bus bars of the preceding paragraph and an apparatus comprising a plurality of conductive elements, with the first connection element of bus bars of the plurality of bus bars being each electrically connected with a conductive element of the plurality of conductive elements.

### BRIEF DESCRIPTION OF THE DRAWINGS

These and other aspects of the disclosed and claimed concept will be apparent from the following Description of the Preferred Embodiment when read in conjunction with the accompanying drawings in which:

FIG. 1 is a perspective view of an improved bus bar in accordance with the disclosed and claimed concept;

FIG. 2 is a top plan view of the bus bar of FIG. 1;

FIG. 3 is a right side view of the bus bar of FIG. 1;

FIG. 4 is a perspective view, partially exploded, of an assembly that includes an improved set of bus bars that includes the bus bar of FIG. 1, and that further includes an electrical apparatus to which the set of bus bars are electrically connected;

FIG. 5 is another perspective view of the assembly of FIG. 4;

FIG. 6 is a perspective view of another bus bar of the set of bus bars of FIGS. 4 and 5;

FIG. 7 is a perspective view of another bus bar of the set of bus bars of FIGS. 4 and 5;

FIG. 8 is a perspective view of another bus bar of the set of bus bars of FIGS. 4 and 5;

FIG. 9 is a perspective view of another bus bar of the set of bus bars of FIGS. 4 and 5;

FIG. 10 is a perspective view of another bus bar of the set of bus bars of FIGS. 4 and 5; and

FIG. 11 is a perspective view of the assembly of FIGS. 4 and 5 situated in a set of electrical enclosures.

Similar numerals refer to similar parts throughout the specification.

### DESCRIPTION OF THE PREFERRED EMBODIMENT

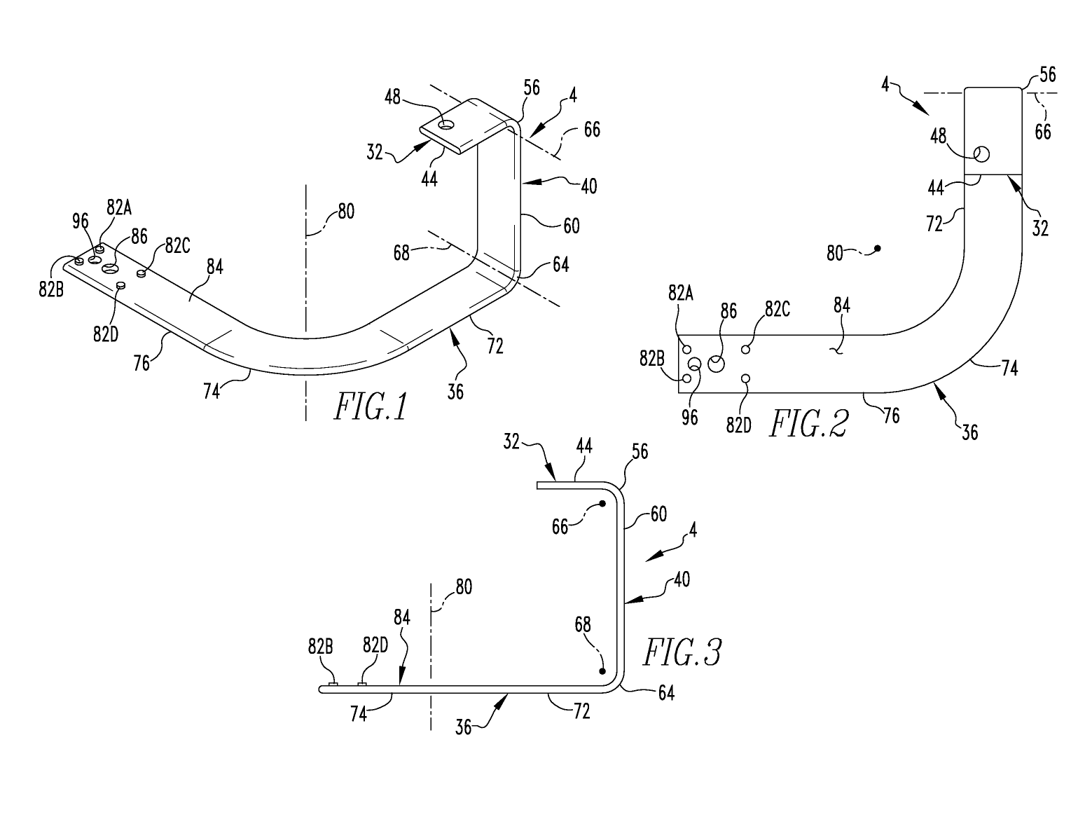

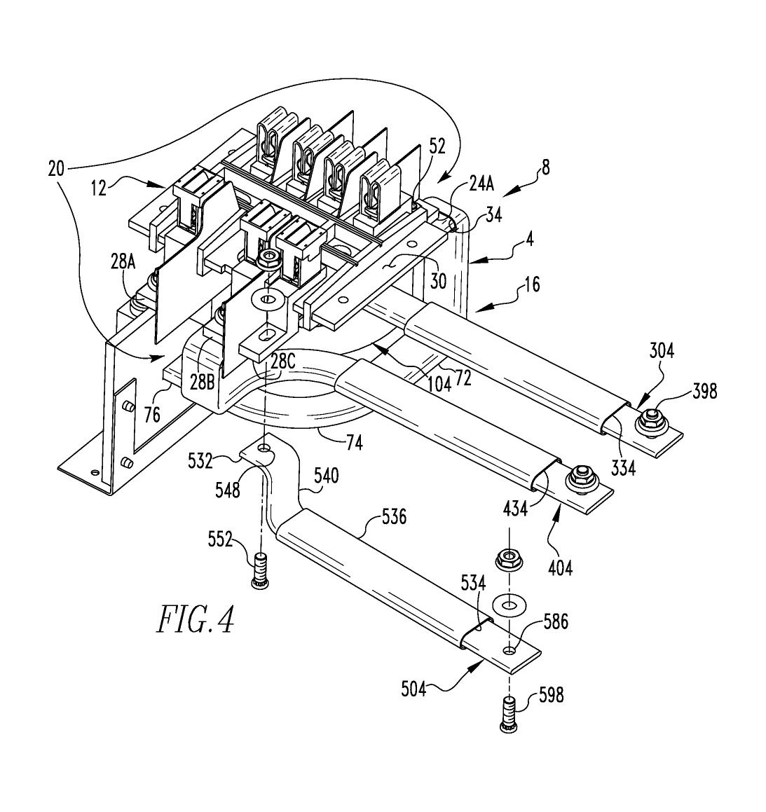

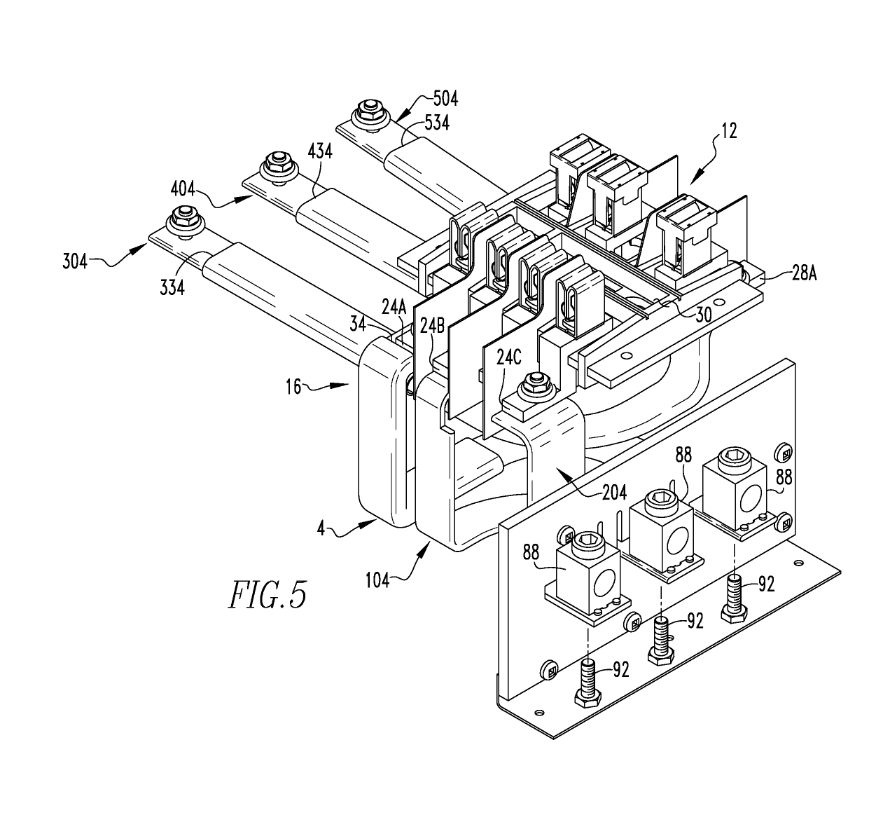

An improved bus bar 4 in accordance with the disclosed and claimed concept is depicted generally in FIGS. 1-3. The bus bar 4 can be said to be part of an assembly 8 that is depicted generally in FIGS. 4 and 5. More particularly, the assembly 8 can be said to include an electrical apparatus 12 and to further include a set of bus bars 16 that includes the bus bar 4. The depicted embodiment of the set of bus bars 16 includes six bus bars including the bus bar 4, but other quantities of bus bars can be employed without departing from the present concept. The exemplary electrical apparatus 12 in the embodiment depicted herein is a mount for an electrical meter, although it is understood that numerous other types of electrical devices without limitation can be employed with the set of bus bars 16 as depicted herein or as slightly modified to suit the application without departing from the scope of the disclosed and claimed concept.

The electrical apparatus 12 includes a plurality of conductive elements 20 to which the set of bus bars 16 can be electrically attached. More particularly, the plurality of conductive elements 20 include three load conductive elements 24A, 24B, and 24C and three line conductive elements 28A, 28B, and 28C. The load conductive elements 24A, 24B, and 24C are connected with three bus bars of the set of bus bars 16 which are connected with line conductors. The line conductive elements 28A, 28B, and 28C are electrically connected with the other three bus bars of the set of bus bars 16.

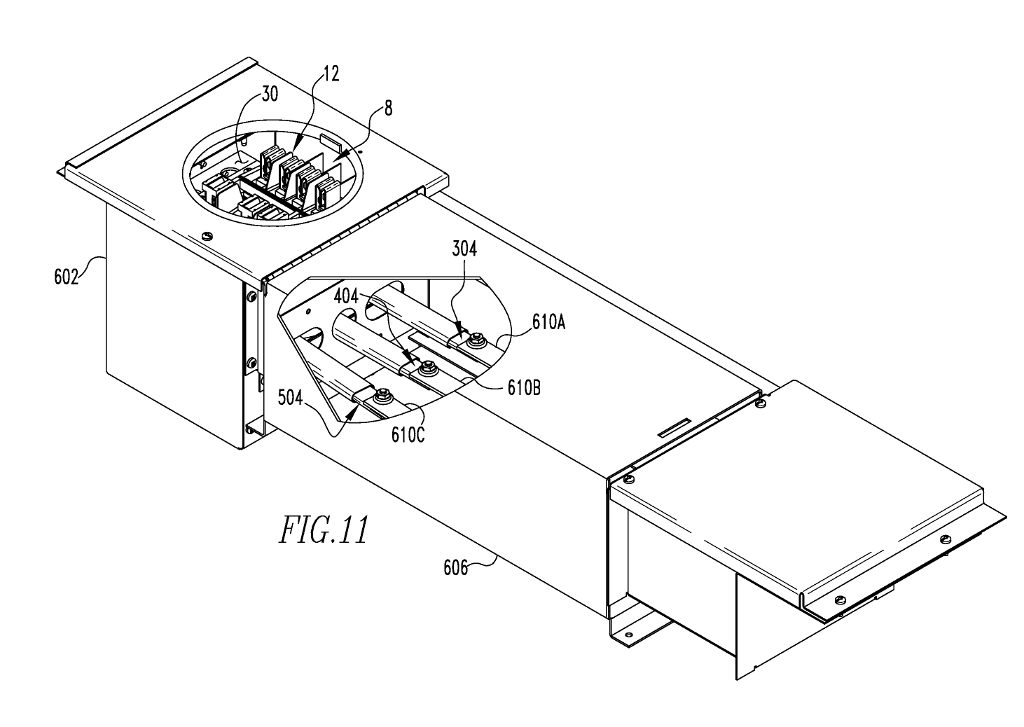

As can further be understood from FIGS. 4 and 5, the set of bus bars 16 can be said to include the bus bar 4, a bus bar 104, a bus bar 204, a bus bar 304, a bus bar 404, and a bus bar 504, with the bus bar 504 being depicted in FIG. 4 as being exploded away from the electrical apparatus 12. In the embodiment depicted herein, the set of bus bars 16 are bent in complex fashions in order to enable the plurality of conductive elements 20 of the electrical apparatus 12 to be electrically connected with a plurality of line conductors and a plurality of load conductors with the use of conductive bus bars while advantageously allowing adjustment and tightening of the bus bars of the set of bus bars 16 generally solely from a frontal surface 30 of the electrical apparatus 12. That is, the bus bars of the set of bus bars 16 are advantageously bent in such a fashion that they extend behind the rear of the electrical apparatus 12, i.e., at the surface of the electrical apparatus 12 that is opposite the frontal surface 30, without requiring operations such as the tightening of fasteners and the like in the region of the surface of the electrical apparatus 12 that is opposite the frontal surface 30. As will be set forth in greater detail in connection with FIG. 11, while the frontal surface 30 is generally accessible when the assembly 8 is situated in an electrical enclosure, the surface of the electrical apparatus 12 that is opposite the frontal surface 30 is in a region within the interior of such electrical enclosure that is generally inaccessible. The configuration of the bus bars 4, 104, 204, 304, 404, and 504 of the set of bus bars 16 thus advantageously facilitates assembly and installation by avoiding the need to perform operations in inaccessible regions. While the bus bars 4, 304, 404, and 504 are depicted in FIGS. 4 and 5 as having insulative sleeves 34, 334, 434, and 534 extending along the exterior of at least a portion thereof, it is noted that such insulative sleeves 34, 334, 434, and 534 are purely optional and may be employed or deleted depending upon the needs of the particular application.

As can be best understood from FIGS. 1-3, the bus bar 4 includes a first connection element 32, a second connection element 36, and an intermediate connection element 40, with the intermediate connection element 40 being electrically situated between the first and second connection elements 32 and 36. The first connection element 32 includes a plate-like conductor 44 having a hole 48 formed therein. As can be understood from FIG. 4, both in connection with the bus bar 4 itself as well as in connection with the bus bar 504, the hole 48 of the bus bar 4 has a fastener 52 received therein, much like the bus bar 504 in FIG. 4 can be seen to have a fastener 552 received in the hole 548 formed in its own first connection member 532. In the embodiment depicted herein, the bus bars 4, 104, 204, 304, 404, and 504 each have a fastener received in a hole formed in a first connection element such as in the way the fasteners 52 and 552 are received in the holes 48 and 548 of the bus bars 4 and 504, respectively, although not all such holes and fasteners are identified herein with a numeral.

In the embodiment depicted herein, the fasteners 52 and 552 are cylindrical threaded fasteners having splines at the end of the shank near the head that are received with an interference fit in the holes 48 and 548. The fasteners such as the fasteners 52 and 552 are connectable with and cooperate with a washer and a nut to fasten each of the bus bars 4, 104, 204, 304, 404, and 504 of the set of bus bars 16 into electrical connection with the plurality of conductive elements 20.

As can further be understood from FIGS. 1-3, the intermediate connection element 40 includes a first bend element 56, a middle element 60, and a second bend element 64, with the middle element 60 being electrically situated and connecting between the first and second bend elements 56 and 64. The first bend element 56 is electrically connected with the first connection element 32, and the second bend element 64 is electrically connected with the second connection element 36. The first bend element can be said to extend about a first bend axis 66, and the second bend element 64 can likewise be said to extend about a second bend axis 68, with the first and second bend axes 66 and 68 being oriented substantially parallel with one another and spaced apart.

In the embodiment depicted herein, the bus bar 4 and the bus bars 104, 204, 304, 404, and 504 are each formed from a single bar of a conductive material such as copper which is bent or otherwise deformed to form the finished shape as depicted in the accompanying figures. The bus bars 4, 104, 204, 304, 404, and 504 thus are each of a monolithic, single piece construction that is substantially free of seams or joints therein. It is also known that other formation methodologies such as casting, forging, and virtually any other formation methodology that can result in the set of bus bars 16 as depicted and/or claimed herein may be employed without departing from the present concept. In the embodiment depicted herein, the bar of stock of the conductive material is cold formed to result in the bus bars 4, 104, 204, 304, 404, and 504 as depicted herein.

As can be understood from FIGS. 1 and 3, the first and second connection elements 32 and 36 can be said to extend in a common direction away from the middle element 60, i.e., extending in the same direction from the middle element 60, such that a portion of the first and second connection elements 32 and 36 overlie one another, as is particularly demonstrated in FIGS. 2 and 3.

As can best be understood from FIGS. 1 and 2, the second connection element 36 can be said to sequentially include a generally straight first segment 72, an arcuate curved segment 74, and a generally straight second segment 76 that are electrically connected together. The curved segment 74 can be said to extend about a curve axis 80 that is oriented substantially perpendicular to the first and second bend axes 66 and 68. For instance, it is noted that in FIG. 2 the first and second bend axes 66 and 68 overlie one another and the curve axis 80 extends perpendicularly out of the plane of the page of FIG. 2. In FIG. 3, the first and second bend axes 66 and 68 extend perpendicularly out of the plane of the page of FIG. 3.

The second connection element 36 has a generally planar surface 84 that extends along the first segment 72, the curved segment 74, and the second segment 76. However, the second segment 76 also has a plurality of protrusions 82A, 82B, 82C, and 82D protruding outwardly from the substantially planar surface 84. In the embodiment depicted herein, the protrusions 82A, 82B, 82C, and 82D are formed in the second segment 76 through an embossment procedure, but other methods can be employed to form the protrusions 82A, 82B, 82C, and 82D without departing from the present concept.

The second segment 76 also has a hole 86 formed therein, with the protrusions 82A, 82B, 82C, and 82D being situated about the hole 86. The hole 86 and the protrusions 82A, 82B, 82C, and 82D are configured to facilitate the mounting to the second segment 76 of a connector such as the wire connector 88, as is depicted generally in FIG. 5. More particularly, the wire connector 88 includes a fastening element 92 that extends through the hole 86 and is threadably received on a corresponding hole on the underside of the wire connector 88. A tab on the underside of the wire connector 88 is received in an anti-rotation hole 96 that is depicted in FIGS. 1 and 2. More particularly, and as can be understood from FIG. 5, when the wire connector 88 is mounted to the second segment 76, the protrusions 82A and 82B are disposed at one end of the wire connector 88, and the protrusions 82C and 82D (not expressly depicted in FIG. 5) are disposed at an opposite end of the wire connector 88. By situating the wire connector 88 between the pair of protrusions 82A and 82B and the pair of protrusions 82C and 82D, and by receiving the tab in the anti-rotation hole 96, the fastening element 92 can be used to fasten the wire connector 88 to the second connection element 36 without a meaningful concern that the wire connector 88 will rotate about the hole 86 when installed. That is, the disposition of the protrusions 82A, 82B, 82C, and 82D adjacent the opposite ends of the wire connector 88 and the reception of the tab in the anti-rotation hole 96 resist rotation of the wire connector 88 about the hole 86 Also, when a conductor is received in the opening formed in the wire connector 88 and the set screw is tightened thereon, the disposition of the protrusions 82A, 82B, 82C, and 82D adjacent the opposite ends of the wire connector 88 and the reception of the tab in the anti-rotation hole 96 will likewise resist vibration and magnetic fields from causing the wire connector 88 to rotate about the hole 86. It thus can be understood that the wire connector 88 mounted to the second segment 76 enables the second connection element 36 to be connected with a conductor.

As can be seen from FIG. 4, the bus bar 504 also has a hole 586 formed therein. The hole is structured to non-rotatably receive a fastener 598 therein in a fashion similar to the way in which the fastener 552 is received in the hole 548.

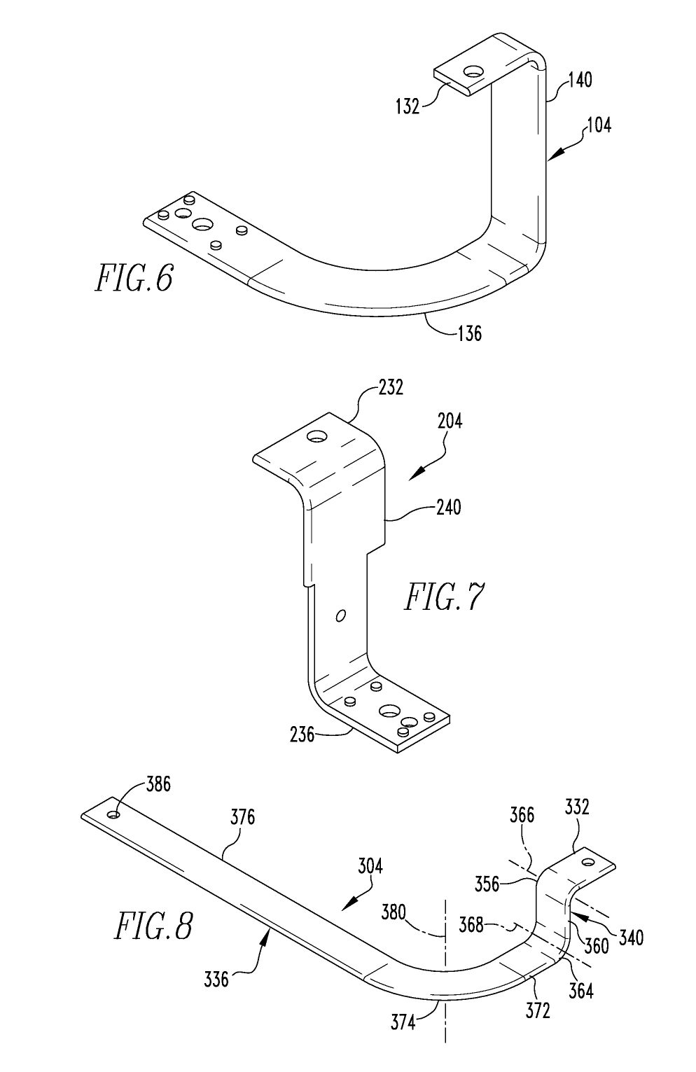

As can be understood from FIG. 6, the bus bar 104 is very similar to the bus bar 4, in that it includes a first connection element 132, a second connection element 136, and an intermediate connection element 140 electrically situated between the first and second connection elements 132 and 136. However, it can be seen that the second connection element 136 has smaller straight segments than the second connection element 36 of the bus bar 4. The bus bar 104 is intended to connect to a different one of the load conductive elements 24A, 24B, and 24C than the bus bar 4.

The bus bar 204 is depicted generally in FIG. 7 and can likewise be seen as having a first connection element 232, a second connection element 236, and an intermediate connection element 240 electrically situated between the first and second connection elements 232 and 236. However, the first and second connection elements 232 and 236 extend in opposite directions away from the intermediate connection element 240. Moreover, the second connection element 236 includes only a substantially straight plate-like segment without including a curved segment such as is indicated at the numeral 74 in the bus bar 4. The bus bar 204 is intended to connect to a different one of the load conductive elements 24A, 24B, and 24C than the bus bars 4 and 104.

The bus bars 304, 404, and 504 are depicted generally in FIGS. 8, 9, and 10, respectively. Whereas the bus bars 4, 104, and 204 are intended to be connected with the load conductive elements 24A, 24B, and 24C of the electrical apparatus 12, the bus bars 304, 404, and 504 are intended to be connected with the line conductive elements 28A, 28B, and 28C.

As can be understood from FIG. 8, the bus bar 304 includes a first connection element 332, a second connection element 336, and an intermediate connection element 340 that is electrically situated between the first and second connection elements 332 and 336. The intermediate connection element 340 includes a first bend element 356, a middle element 360, and a second bend element 364, with the middle element 360 being electrically interposed between the first and second bend elements 356 and 364. The first and second bend elements 356 and 364 extend about a first bend axis 366 and second bend axis 368, respectively, which are parallel and spaced apart from one another. It can be seen, however, that the first and second bend elements 356 and 364 are concave in substantially opposite directions whereby the first and second connection elements 332 and 336 can be said to extend in opposite directions away from the middle element 360.

It is noted, however, that the second connection element 336 includes a generally straight first segment 372, a curved segment 374, and a generally straight second segment 376, with the curved segment 374 being electrically situated between the first and second segments 372 and 376. Thus, it can be seen that it is most particularly the first connection element 332 and the first segment 372 that extend away from the middle element 360 in opposite directions therefrom.

It also can be understood that the curved segment 374 extends about a curve axis 380, much in the way of the second connection elements 36 and 136 of the bus bars 4 and 104. The curve axis 380 is likewise oriented substantially perpendicular to the first and second bend axes 366 and 368.

It is noted that the second connection element 336 includes at its free end a hole 386 that is structured to receive therein a fastener 398 as is depicted generally in FIGS. 4 and 5 and which is non-rotatably received in the hole 386. That is, the fastener 398 includes a plurality of longitudinal splines that are received with an interference fit in the hole 386 such that the fastener 398 which is received in the hole 386 will not be rotatable with respect to the hole 386 under the rotational forces that could be experienced in the environment of the bus bar 304. Alternatively, the hole 386 and most of the other holes of the set of bus bars 16 can be of a non-circular shape, such as a rectangular shape, and the fastener can have a corresponding shape to facilitate the resistance to rotation of the fastener received therein. As can be understood from FIGS. 4 and 5, the fastener 398 cooperates with a washer and a nut to enable connection of the second connection element 336 with a line conductor.

The curved segment 374 can be said to subtend an arc in the range of about 80 degrees to 100 degrees and, more preferably subtends an arc of about 90 degrees with respect to the curve axis 380. The same can be said of the curve segments of the bus bars 4, 104, and 404. Moreover, the same can be said of the first and second bend elements 356 and 364 of the bus bar 304, as well as of the first and second bend elements 56 and 64 of the bus bar 4.

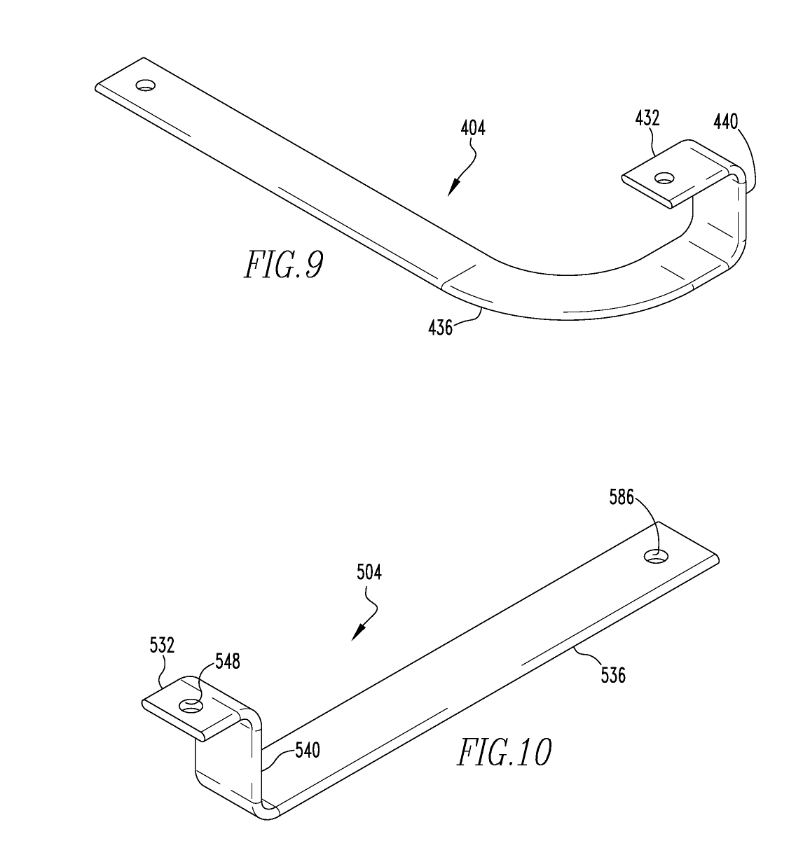

As can be understood from FIG. 9, the bus bar 404 is similar to the bus bar 304 in that it includes a first connection element 432, a second connection element 436, and an intermediate connection 440 that is electrically situated between the first and second connection elements 432 and 436. However, it can also be seen from FIG. 9 that the bend elements of the intermediate connection element 440 are concave in a common direction, whereby the first and second connection elements 432 and 436 each extend in a common direction away from the intermediate connection element 440 and at least partially overlie one another. As can be understood from the foregoing, it is more particularly the straight first segment of the second connection element 436 that can be said to extend in the common direction with the first connection element 432 and to be in the overlying relationship.

FIG. 10 depicts the bus bar 504 as having a first connection element 532, a second connection element 536, and an intermediate connection element 540, with the intermediate connection element 540 being electrically situated between the first and second connection elements 532 and 536. The first and second connection elements 532 and 536 extend in opposite directions away from the intermediate connection element 540. It is also noted that the second connection element 536 does not include a curve segment, and rather has only a single substantially straight plate-like conductor having a hole 548 formed therein.

As can be understood from FIGS. 4 and 5, the set of bus bars 16 are connected to the plurality of conductive elements 20 using the fasteners 52, 552, and the other fasteners that are similar thereto that are received with an interference fit in the holes formed in the first connection elements 32, 132, 232, 332, 432, and 532. The washers and nuts are threaded thereon and only tightened to a finger-tight condition to thereby enable a certain degree of movement of the bus bars 4, 104, 204, 304, 404, and 504 with respect to the electrical apparatus 12. The assembly 8 is then received in a first enclosure 602 as is indicated generally in FIG. 11. In so doing, the free ends of the bus bars 304, 404, and 504 are received through holes formed in an end of a second enclosure 606 adjacent the first enclosure 602 and are received within the interior of the second enclosure 606. The fastener 398 of the bus bar 304 and the similar fasteners at the free ends of the second connection elements 436 and 536 of the bus bars 404 and 504 are connected with line conductors 610A, 610B, and 610C that are situated within the second enclosure 606. By previously tightening the fasteners that are connected with the line conductive elements 28A, 28B, and 28C to only a finger-tight condition, the bus bars 304, 404, and 504 are slightly movable with respect to the electrical apparatus 12 and with respect to the line conductors 610A, 610B, and 610C in order to enable them to be aligned with and fastened to the line conductors 610A, 610B, and 610C. Once the bus bars 304, 404, and 504 are electrically connected with the line conductors 610A, 610B, and 610C and the fasteners such as the fastener 398 tightened therebetween, the fasteners (such as the fastener 552) of the bus bars 304, 404, and 504 that are connected in a finger tightened condition with the line conductive elements 28A, 28B, and 28C are likewise tightened. In this regard, it can be understood that such tightening occurs at the frontal surface 30 of the electrical apparatus 12, which is advantageously relatively easy since no connections that are inaccessible from the frontal surface 30 require attention in the exemplary depicted embodiment.

Similarly, the wire connectors 88 that are situated on the second connection elements 36, 136, and 236 of the bus bars 4, 104, and 204 can receive therein the wires that serve as the load conductors. In this regard, if the load conductors are something other than wires, different types of connectors can be employed in place of the wire connector 88. In any event, once the load conductors are received and tightened in the wire connectors 88, the fasteners (such as the 52) of the bus bars 4, 104, and 204 can be tightened to the load conductive elements 24A, 24B, and 24C, again with such tightening being from the frontal surface 30 of the electrical apparatus 12.

It thus can be seen that the set of bus bars 16 and their combination with the electrical apparatus 12 to form the assembly 8 is easier to install and assemble than previously known solutions because the complex bending of the bus bars of the set of bus bars 16 enables them to extend behind the electrical apparatus 12, i.e., along the surface opposite the frontal surface 30, without needing the tightening of mechanical connections at such location, which would otherwise be inaccessible within the first enclosure 602. The resultant system advantageously saves time and effort is less expensive to manufacture because it requires less material, and it requires a lesser quantity of components.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A conductive bus bar comprising:
a first connection element structured to be electrically connected with a conductive element of an apparatus;
a second connection element structured to be electrically connected with a conductor;
an intermediate connection element electrically extending between the first and second connection elements;
the intermediate connection element comprising a first bend element, a middle element, and a second bend element;
the first bend element electrically extending between the first connection element and the middle element; and
the second bend element electrically extending between the second connection element and the middle element.

2. The conductive bus bar of claim 1 wherein the first connection element comprises a plate-like conductor having a hole formed therein.

3. The conductive bus bar of claim 2 wherein the first connection element further comprises a fastener non-rotatably received in the hole.

4. The conductive bus bar of claim 2 wherein the second connection element comprises another plate-like conductor having another hole formed therein.

5. The conductive bus bar of claim 4 wherein the second connection element further comprises a plurality of protrusions that protrude from a surface of the another plate-like conductor and that are situated about the another hole, the second connection element being structured to receive between at least a pair of the protrusions a wire connector that is structured to be attached to the second connection element with a fastener that extends through the another hole.

6. The conductive bus bar of claim 1 wherein at least a portion of the first connection element and at least a portion of the second connection element extend in a common direction from the intermediate connection element.

7. The conductive bus bar of claim 6 wherein at least a portion of one of the first and second connection elements overlies at least a portion of the other of the first and second connection elements.

8. The conductive bus bar of claim 1 wherein at least a portion of the first connection element and at least a portion of the second connection element extend in substantially opposite directions from the intermediate connection element.

9. The conductive bus bar of claim 1 wherein the first bend element extends about a first bend axis and wherein the second bend element extends about a second bend axis, and wherein at least a portion of at least one of the first and second connection elements includes a first segment, a curve segment, and a second segment, the curve segment being electrically connected between the first and second segments, the curve segment extending about a curve axis that is oriented substantially perpendicular to at least one of the first bend axis and the second bend axis.

10. The conductive bus bar of claim 9 wherein the curve segment subtends an arc with respect to the curve axis in the range of about 80 degrees to 100 degrees.

11. A set of conductive bus bars that comprises a plurality of bus bars, at least some of the bus bars of the plurality of bus bars each comprising:
a first connection element structured to be electrically connected with a conductive element of an apparatus;
a second connection element structured to be electrically connected with a conductor;
an intermediate connection element electrically extending between the first and second connection elements;
the intermediate connection element comprising a first bend element, a middle element, and a second bend element;
the first bend element electrically extending between the first connection element and the middle element; and
the second bend element electrically extending between the second connection element and the middle element.

12. The set of conductive bus bars of claim 11 wherein the first connection element of at least a first bus bar from among the plurality of bus bars comprises a plate-like conductor having a hole formed therein.

13. The set of conductive bus bars of claim 12 wherein the first connection element of the at least first bus bar further comprises a fastener non-rotatably received in the hole.

14. The set of conductive bus bars of claim 12 wherein the second connection element of the at least first bus bar comprises another plate-like conductor having another hole formed therein.

15. The set of conductive bus bars of claim 14 wherein the second connection element of the at least first bus bar further comprises a plurality of protrusions that protrude from a surface of the another plate-like conductor and that are situated about the another hole, the second connection element being structured to receive between at least a pair of the protrusions a wire connector that is structured to be attached to the second connection element with a fastener that extends through the another hole.

16. The set of conductive bus bars of claim 11 wherein at least a portion of the first connection element of at least a first bus bar from among the plurality of bus bars and at least a portion of the second connection element of the at least first bus bar extend in a common direction from the intermediate connection element.

17. The set of conductive bus bars of claim 16 wherein at least a portion of one of the first and second connection elements of the at least first bus bar overlies at least a portion of the other of the first and second connection elements.

18. The set of conductive bus bars of claim 11 wherein at least a portion of the first connection element of at least a first bus bar from among the plurality of bus bars and at least a portion of the second connection element of the at least first bus bar extend in substantially opposite directions from the intermediate connection element.

19. The set of conductive bus bars of claim 11 wherein the first bend element of at least a first bus bar from among the plurality of bus bars extends about a first bend axis and wherein the second bend element of the at least a first bus bar extends about a second bend axis, and wherein at least a portion of at least one of the first and second connection elements of the at least a first bus bar includes a first segment, a curve segment, and a second segment, the curve segment being electrically connected between the first and second segments, the curve segment extending about a curve axis that is oriented substantially perpendicular to at least one of the first bend axis and the second bend axis.

20. An assembly comprising the set of conductive bus bars of claim 11 and an apparatus comprising a plurality of conductive elements, the first connection elements of the bus bars of the plurality of bus bars being each electrically connected with a conductive element of the plurality of conductive elements.
